(19) United States
(12) Patent Application Publication
(10) Pub. No.: US 2025/0245304 A1
(43) Pub. Date: Jul. 31, 2025

(54) DETERMINING ACCESS RIGHTS FOR A COMPONENT BASED ON USERNAME INCLUSION IN THE COMPONENT'S NAME

(71) Applicant: SIGNIFY HOLDING B.V., EINDHOVEN (NL)

(72) Inventor: LEENDERT TEUNIS ROZENDAAL, VALKENSWAARD (NL)

(21) Appl. No.: 18/878,370

(22) PCT Filed: Jun. 21, 2023
(86) PCT No.: PCT/EP2023/066755

§ 371 Date: Dec. 23, 2024

(30) Foreign Application Priority Data
Jun. 28, 2022 (EP) 22181522.8

(51) Int. Cl. G06F 21/31

(52) U.S. Cl. CPC G06F 21/31

(57) ABSTRACT

A system (1) is configured to obtain component information specifying names (51-53) of components (31-33) of the lighting system, obtain user information specifying user names (59), look up a component name of a component of the lighting system in the component information, determine access rights for the component by determining whether the component name comprises a user name of the user names, and store the access rights in a memory. The system is further configured to receive a request to access the component, the request identifying a requestor (49), determine, based on the access rights for the component stored in the memory, whether the requestor is allowed to access the component, and access the component upon determining that the requestor is allowed to access the component.

### FIELD OF THE INVENTION

The invention relates to a system for accessing a component of a lighting system.

The invention further relates to a method of accessing a component of a lighting system.

The invention also relates to a computer program product enabling a computer system to perform such a method.

### BACKGROUND OF THE INVENTION

With the introduction of smart, connected lighting systems, it has become more work for users to commission the lighting systems. Often, commissioning a lighting system involves naming the components of the lighting system, e.g. lighting devices, light scenes, sensors, and/or automations. This is the case in the Philips Hue system, for example.

U.S. Pat. No. 20,200,77476 A1 discloses a system for controlling lighting devices includes a processor in communication with a portable electronic device. The processor is configured to receive geolocation data corresponding to an electronic device, and identify one or more light-enabled facilities that are within a distance range of the electronic device. Each of the light-enabled facilities comprises a controller that is communicatively coupled to one or more lighting devices in a network of lighting devices. The system is further configured to receive a light operation request comprising a selected one of the light-enabled facilities and a scene from the electronic device, and transmit the light operation request to cause the controller to activate at least one lighting device at the selected light enabled facility according to the scene to the controller at the selected light-enabled facility.

Methods are known that make it easier to commission such a lighting system. For example, US 2017/0105095 A1 discloses a method which includes receiving data from a plurality of devices, determining a correlation between at least two devices among the plurality of devices on the basis of the received data, determining a position of a first device on the basis of the correlation, grouping the first device and another device positioned in the vicinity of the first device into one group, and automatically creating group information, and controlling the devices included in the group. In an embodiment, the name of the first device is automatically set using the group information, e.g. to “Father's room”.

However, in the future, it is expected to take even more work for a user to commission a lighting system. In current lighting systems, often, any user or app can control or setup any light, scene, automation, etc.. This is the case in the Philips Hue system, for example. In the future, it is expected that access control will be implemented in lighting systems to limit access rights. In such a system, certain users or apps would have limited rights, e.g. would be able to control lights in one area but no other lights and would not be able to configure scenes or automations. While this is a great mechanism to limit “who can do what”, setting up the rules can be a tedious process as there are many devices and several users.

### SUMMARY OF THE INVENTION

It is a first object of the invention to provide a system, which can be used to set up access control in a lighting system more easily.

It is a second object of the invention to provide a method, which can be used to set up access control in a lighting system more easily.

In a first aspect of the invention, a system for accessing a component of a lighting system comprises at least one input interface, at least one output interface, and at least one processor configured to obtain component information specifying names of components of said lighting system, obtain user information specifying user names, look up a component name of a component of said lighting system in said component information, determine access rights for said component by determining whether said component name comprises a user name of said user names, store said access rights in a memory, receive, via said at least one input interface, a request to access said component, said request identifying a requestor, determine, based on said access rights for said component stored in said memory, whether said requestor, associated with a user name of said user names, is allowed to access said component, and access said component via said at least one output interface upon determining that said requestor is allowed to access said component.

This system benefits from the fact that names for components in a smart lighting system often contain a name of a person living in that home, e.g. “Roy's switch”, “Roy's reading lamp”, “Tina's bed light”. This system uses this information to automatically prepopulate the access rights based on matching names of components of a lighting system (e.g. room/scenes/lights/sensors) with names of users. The automated default setup provided by this system may take away a lot of manual effort and thus will be valued by the users. Accessing said component may comprise controlling said component and/or configuring said component. Said components of said lighting system may comprise one or more of: a lighting device, a sensor, a light scene, and an automation. The component information and the user information may be obtained from internal memory or from a further system, e.g. a bridge or a cloud computer.

Said at least one processor may be configured to determine said access rights for said component by enabling access to said component by a certain requestor if a username associated with said certain requestor is included in said component name, said user name being included in said user names.

For example, a user (Roy) is given access rights for the devices which have the user's name in the name of the device (“Roy's switch”, “Roy's reading lamp ”) but not for other devices (e.g. “Tina's bed light”, “bathroom light”).

Said at least one processor may be configured to determine said access rights for said component by enabling access to said component by a plurality of requestors, e.g. any requestor, if said component name does not include any of said user names. For example, access rights are given for all devices which do not have the name of another user in the device name. This would give Roy also access to e.g. “bathroom light” but not to “Tina's bed light”.

Said component information may further specify names of component groups of said lighting system and said at least one processor may be configured to look up a group name of a group of said component in said component information, and determine said access rights for said component by determining whether said component name or said group name comprises a user name of said user names. User names may also be used in group names, e.g. “Roy's room” or “Roy's game lights”. By also looking at the group names when prepopulating the access rights, the system may take away additional manual effort.

Said at least one processor may be configured to determine said access rights for said component by enabling access to said component by a certain requestor if a user name associated with said certain requestor is included in said component name or in said group name, said user name being included in said user names. For example, a user (Roy) is given access rights for the devices which have the user's name in the name of the device or name of the group (“Roy's room”, “Roy's switch”, “Roy's game lights”) but not for other devices (e.g. “Tina's bed light”, “bathroom light”). For instance, Roy is given access rights to a lighting device which does not have “Roy” in the name (e.g. “PC lights”) if this lighting device is in “Roy's room”.

Said at least one processor may be configured to determine said access rights for said component by enabling access to said component by a plurality of requestors, e.g. any requestor, if neither said component name nor said group name includes any of said user names. Thus, access rights are given for all devices which do not have the name of another user in the device or group name. This would give Roy also access to e.g. “bathroom light” in the group named “second floor” but not to “Tina's bed light”.

Said at least one processor may be configured to obtain an input signal indicative of a modification to said access rights for said component requested by an authorized requestor, and make said modification of said access rights in said memory. Thus, the automatic population of the access rights may be used as starting point for further finetuning by the user/administrator.

Said at least one processor may be configured to obtain at least part of said user information from at least one user device, said part of said user information specifying one or more user names associated with one or more accounts on said at least one user device. Persons typically have their name exposed by their smartphone, e.g. “Roy's iPhone” and this may be used to grant default rights based on the name of the phone. Said at least one user device may comprise a user device which is capable of transmitting said request to access said component, e.g. a mobile phone running a lighting control app. In this case, the user may be able to specify a user name in the lighting control app, for example. This effectively creates an account for the user in the lighting control app. This is beneficial, for example, if the user's name is not exposed in the name of the user device.

In a second aspect of the invention, a method of accessing a component of a lighting system comprises obtaining component information specifying names of components of said lighting system, obtaining user information specifying user names, looking up a component name of a component of said lighting system in said component information, determining access rights for said component by determining whether said component name comprises a user name of said user names, storing said access rights in a memory, receiving a request to access said component, said request identifying a requestor, determining, based on said access rights for said component stored in said memory, whether said requestor, associated with a user name of said user names, is allowed to access said component; and accessing said component upon determining that said requestor is allowed to access said component. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for accessing a component of a lighting system.

The executable operations comprise obtaining component information specifying names of components of said lighting system, obtaining user information specifying user names, looking up a component name of a component of said lighting system in said component information, determining access rights for said component by determining whether said component name comprises a user name of said user names, storing said access rights in a memory, receiving a request to access said component, said request identifying a requestor, determining, based on said access rights for said component stored in said memory, whether said requestor is allowed to access said component; and accessing said component upon determining that said requestor is allowed to access said component.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(™), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 shows examples of component names and a user name used in the system of FIG. 1;

FIG. 3 is a block diagram of a second embodiment of the system;

FIG. 4 is a flow diagram of a first embodiment of the method;

FIG. 5 is a flow diagram of a second embodiment of the method;

FIG. 6 is a flow diagram of a third embodiment of the method; and

FIG. 7 is a block diagram of an exemplary data processing system for performing the method of the invention.

Corresponding elements in the drawings are denoted by the same reference numeral.

### DETAILED DESCRIPTION OF THE EMBODIMENTS

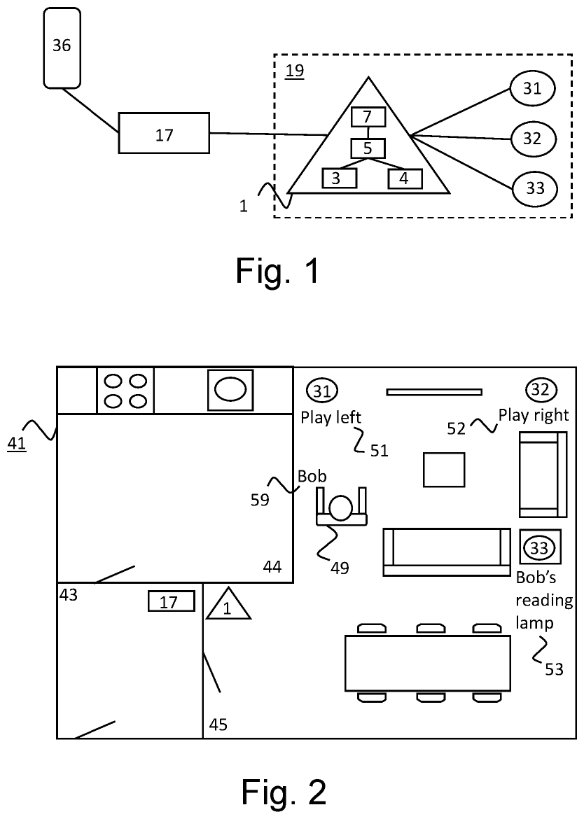

FIG. 1 shows a first embodiment of the system for accessing a component of a lighting system. In this first embodiment, the system is a bridge 1. The bridge 1 may be a Philips Hue bridge, for example. In the example of FIG. 1, a lighting system 19 comprises the bridge 1 and three lighting devices 31-33. The lighting devices 31-33 communicate with the bridge 1, e.g. using Zigbee technology.

The bridge 1 is connected to a wireless LAN access point 17, e.g. via Ethernet or Wi-Fi. A user device 36, e.g. a mobile phone, is also connected to the wireless LAN access point 17. The user device 36 is able to control the lighting devices 31-33 via the wireless LAN access point 17 and the bridge 1 when the user is at home. The user device 36 runs an app for controlling light sources 31-33, for example.

The bridge 1 comprises a receiver 3, a transmitter 4, a processor 5, and a memory 7. The processor 5 is configured to obtain component information specifying names of components of the lighting system 19, obtain user information specifying user names, look up a component name of a component of the lighting system 19 in the component information, determine access rights for the component by determining whether the component name comprises a user name of the user names, and store the access rights in a memory, e.g. memory 7.

The component information may be obtained from memory 7, for example. Access rights may be determined for all components of the lighting system 19. Lighting devices 31-33 are considered components of the lighting system 19. Other components of the lighting system 19 may include, for example, a sensor, a light scene, and/or an automation. The user information, or part thereof. may be provided, for example, by an administrator of the lighting system, e.g. by using user device 36.

The processor 5 is further configured to receive, via the receiver 3, a request to access the component, e.g. from the user device 36. The request identifies a requestor. The processor 5 is further configured to determine, based on the access rights for the component stored in the memory, e.g. memory 7, whether the requestor is allowed to access the component, and access the component via the transmitter 4 upon determining that the requestor is allowed to access the component.

Accessing the component may comprise controlling the component and/or configuring the component. For example, the access rights may specify who may control a lighting device and/or who may configure a sensor, a light scene, and/or an automation. A light scene specifies one or more colors. An automation may for example activate a certain light scene at sunrise or sunset. Access rights may be granted, for example, for those lighting devices where the name of another user does not appear in the name of the lighting device. Alternatively or additionally, access rights may be granted, for example, when the name of the user appears in the name of the lighting device.

The processor 5 may be configured to obtain at least part of the user information from one or more user devices, e.g. user device 36. The part of the user information specifies one or more user names associated with one or more accounts (e.g. Google account, Samsung account, Apple account) on the at least one user device. The one or more user devices may comprise a user device which is capable of transmitting the request to access the component, e.g. user device 36.

User names may be extracted from the names of user devices, e.g. as advertised via Bluetooth, for example. Alternatively or additionally, a lighting control app may provide information specifying user names entered in the lighting control app (and thus effectively user account information of the lighting control app), for example. Alternatively or additionally, a user device or an app running on the user device may provide information specifying the names of users who have an account on the user device or specifying the name of the current user of the user device, for example. Many user devices support multiple user accounts. FIG. 2 shows examples of component names and a user name used in the system of FIG. 1. FIG. 2 shows the first floor 41 of an example house. The first floor 41 comprises a hallway 43, a kitchen 44, and a living room 45. The bridge 1 and the lighting devices 31-33 of FIG. 1 have been installed in the living room 45. The wireless LAN access point of FIG. 1 has been installed in the hallway 43.

The administrator of the lighting system has named the lighting devices 31-33 “Play left” (name 51), “Play right” (name 52), and “Bob's reading lamp” (name 53), respectively, when installing/commissioning the lighting system. In this example, lighting devices 31 and 32 are Hue Play lighting devices which are used, amongst others, to render entertainment light effects. The entertainment light effects are based on video content and are rendered while a TV displays the video content. The lighting device 31 has been placed to the left of the TV and the lighting device 32 has been placed to the right of the TV.

A person 59 with username Bob (username 59) is currently present in the living room 49. Bob is one of the residents of the house. The administrator of the lighting system, which may even be Bob himself, may have provided Bob's name to the lighting system as a username. Alternatively, the lighting system may have at a certain moment detected Bob's mobile phone, e.g. via Bluetooth, and extracted Bob's name from the name of his mobile phone, e.g. “Bob's phone”. When the lighting system is installed/commissioned, the access rights may be prepopulated based on the user names provided by the administrator at that moment and/or based on the user names extracted from the names of devices detected at that moment. When a new device is later detected, and a new username is obtained, additional access rights may be determined and stored.

When Bob's name (username 59) is obtained, Bob is given access rights to lighting device 33, as the name of lighting device 33 (name 53) comprises Bob's name. None of the other users of the lighting system are initially given access rights to lighting device 53. Authorized users may be able to modify the access rights for each component. In a first implementation of the bridge 1, none of the users of the lighting system are initially given access to lighting devices 31 and 32. In a second implementation of the bridge 1, all users of the lighting system are initially given access to lighting devices 31 and 32, because the names of lighting devices 31 and 32 (names 51 and 52) do not comprise any of the usernames.

In the embodiment of the bridge 1 shown in FIG. 1, the bridge 1 comprises one processor 5. In an alternative embodiment, the bridge 1 comprises multiple processors. The processor 5 of the bridge 1 may be a general-purpose processor, e.g. ARM-based, or an application-specific processor. The processor 5 of the bridge 1 may run a Unix-based operating system for example. The memory 7 may comprise one or more memory units. The memory 7 may comprise solid-state memory, for example. The memory 7 may be used to store a table of connected lights, for example.

The receiver 3 and the transmitter 4 may use one or more wired or wireless communication technologies, e.g. Ethernet for communicating with the wireless LAN access point 17 and Zigbee for communicating with the lighting devices, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The bridge 1 may comprise other components typical for a network device such as a power connector. The invention may be implemented using a computer program running on one or more processors.

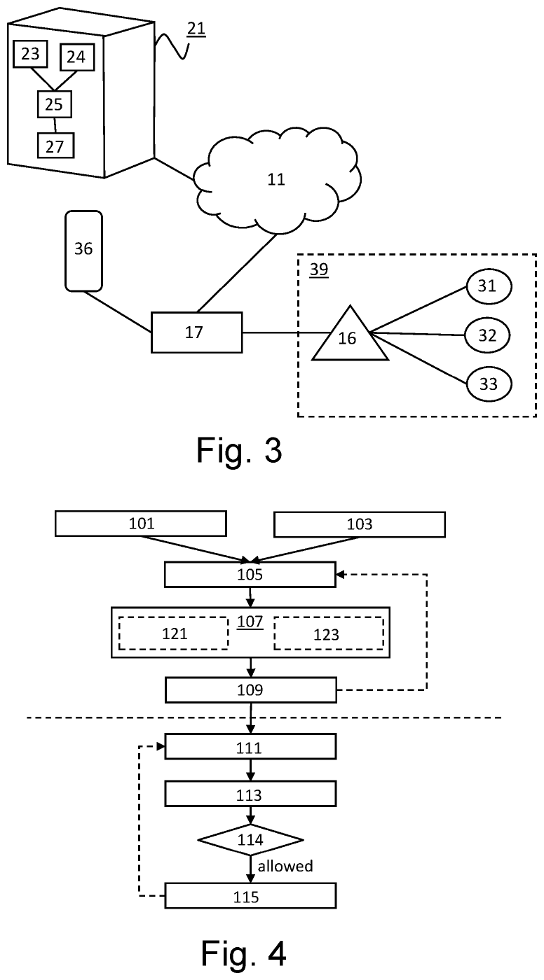

FIG. 3 shows a second embodiment of the system for accessing a component of a lighting system. In this second embodiment, the system is a computer 21. The computer 21 is an Internet server connected to the Internet 11. In the example of FIG. 3, a lighting system 39 comprises a bridge 16 and the three lighting devices 31-33. In the example of FIG. 3, the lighting system 39 comprises a bridge. Alternatively, the lighting system 39 might not comprise a bridge.

The computer 21 comprises a receiver 23, a transmitter 24, a processor 25, and memory 27. The processor 25 is configured to obtain component information specifying names of components of the lighting system 39, obtain user information specifying user names, look up a component name of a component of the lighting system 39 in the component information, determine access rights for the component by determining whether the component name comprises a user name of the user names, and store the access rights in a memory, e.g. memory 27.

The component information may be obtained from memory 27, for example. Access rights may be determined for all components of the lighting system 39. Lighting devices 31-33 are considered components of the lighting system 39. Other components of the lighting system 39 may include, for example, a sensor, a light scene, and/or an automation. The user information, or part thereof, may be provided, for example, by an administrator of the lighting system, e.g. by using user device 36.

The processor 25 is further configured to receive, via the receiver 23, a request to access the component. The request identifies a requestor. The processor 25 is further configured to determine, based on the access rights for the component stored in the memory, e.g. memory 27, whether the requestor is allowed to access the component, and access the component via the at transmitter 24 upon determining that the requestor is allowed to access the component.

In the embodiment of the computer 21 shown in FIG. 3, the computer 21 comprises one processor 25. In an alternative embodiment, the computer 21 comprises multiple processors. The processor 25 of the computer 21 may be a general-purpose processor, e.g. from Intel or AMD, or an application-specific processor. The processor 25 of the computer 21 may run a Windows or Unix-based operating system for example. The memory 27 may comprise one or more memory units. The memory 27 may comprise one or more hard disks and/or solid-state memory, for example. The memory 27 may be used to store an operating system, applications and application data, for example.

The receiver 23 and the transmitter 24 may use one or more wired and/or wireless communication technologies such as Ethernet and/or Wi-Fi (IEEE 802.11) to connect to the Internet 11, for example. In an alternative embodiment, multiple receivers and/or multiple transmitters are used instead of a single receiver and a single transmitter. In the embodiment shown in FIG. 3, a separate receiver and a separate transmitter are used. In an alternative embodiment, the receiver 23 and the transmitter 24 are combined into a transceiver. The computer 21 may comprise other components typical for a computer such as a power connector. The invention may be implemented using a computer program running on one or more processors.

In the embodiments of FIGS. 1 and 3, the system of the invention comprises a bridge or a computer. In an alternative embodiment, the system of the invention is a different device. In the embodiments of FIGS. 1 and 3, the system of the invention comprises a single device. In an alternative embodiment, the system of the invention comprises a plurality of devices.

A first embodiment of the method of accessing a component of a lighting system is shown in FIG. 4. The method may be performed by the bridge 1 of FIG. 1 or the computer 21 of FIG. 3, for example.

A step 101 comprises obtaining component information specifying names of components of the lighting system. The components may be implemented in hardware and/or in software. The components of the lighting system may comprise one or more of a lighting device, a sensor, a light scene, and an automation, for example. The component information may be obtained from a light controller, e.g. a bridge, or from the cloud, for example. A step 103 comprises obtaining user information specifying user names. For example, an administrator of the lighting system may enter the names of the users.

A step 105 comprises looking up a component name of a component of the lighting system in the component information obtained in step 101. A step 107 comprises determining access rights for the component by determining whether the component name found in step 105 comprises a user name of the user names obtained in step 103.

Step 107 may comprise a sub step 121 and/or a sub step 123. Step 121 comprises enabling access to the component by a certain requestor if a user name associated with the certain requestor is included in the component name. This may be realized by associating the component with the user name(s) included in the component and/or by associating the component with the device(s)/app(s) associated with the user name(s) included in the component name. The requestor may be a device/app or a person.

Step 123 comprises enabling access to the component by a plurality of requestors, e.g. any requestor, if the component name does not include any of the user names. Any requestor may be allowed to access the component if only authenticated devices or devices connected to the same wireless network are able to transmit requests to access the component, for example. If any device can transmit such requests, access to the component may be enabled only for authenticated devices or devices connected to the same wireless network, for example.

A step 109 comprises storing the access rights in a memory. Steps 105 to 109 may be repeated one or more times. Steps 105 to 109 may be performed for each component specified in the component information obtained in step 101. Thus, in multiple iterations of steps 105 to 109, the names of the components, e.g. names of scenes/devices/automations, used in the lighting system may be analyzed for the user names obtained in step 103 to find matches of user names in the component names, e.g. scene/device/automation names.

Later, a step 111 comprises receiving a request to access the component. The request identifies a requestor. A step 113 comprises determining, based on the access rights for the component stored in the memory in step 109, whether the requestor identified in the request received in step 111 is allowed to access the component. A step 114 comprises checking whether it was determined in step 113 that the requestor is allowed to access the component. If so, a step 115 is performed. Step 115 comprises accessing the component upon determining that the requestor is allowed to access the component. Accessing the component may comprise controlling the component and/or configuring the component.

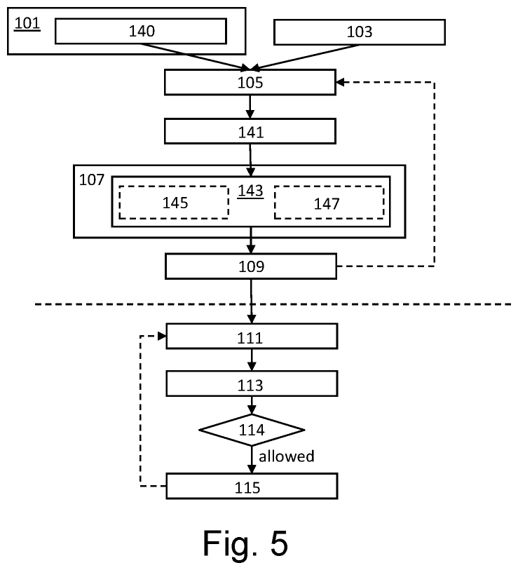

A second embodiment of the method of accessing a component of a lighting system is shown in FIG. 5. The second embodiment of FIG. 5 is an extension of the first embodiment of FIG. 4. In the embodiment of FIG. 5, step 101 of FIG. 4 is implemented by a step 140, a step 141 is performed between steps 105 and 107, and step 107 of FIG. 4 is implemented by a step 143. The method may be performed by the bridge 1 of FIG. 1 or the computer 21 of FIG. 3, for example.

Step 140 comprises obtaining component information specifying names of components of the lighting system and further specifying names of component groups of the lighting system. Step 141 comprises looking up a group name of a group of the component in the component information obtained in step 140. Step 143 comprises determining access rights for the component by determining whether the component name found in step 105 or the group name found in step 141 comprises a user name of the user names obtained in step 103. Step 141 may comprise a sub step 145 and/or a sub step 147.

Step 145 comprises enabling access to the component by a certain requestor if a user name associated with the certain requestor is included in the component name or in the group name. Step 147 comprises enabling access to the component by a plurality of requestors, e.g. any requestor, if neither the component name nor the group name includes any of the user names.

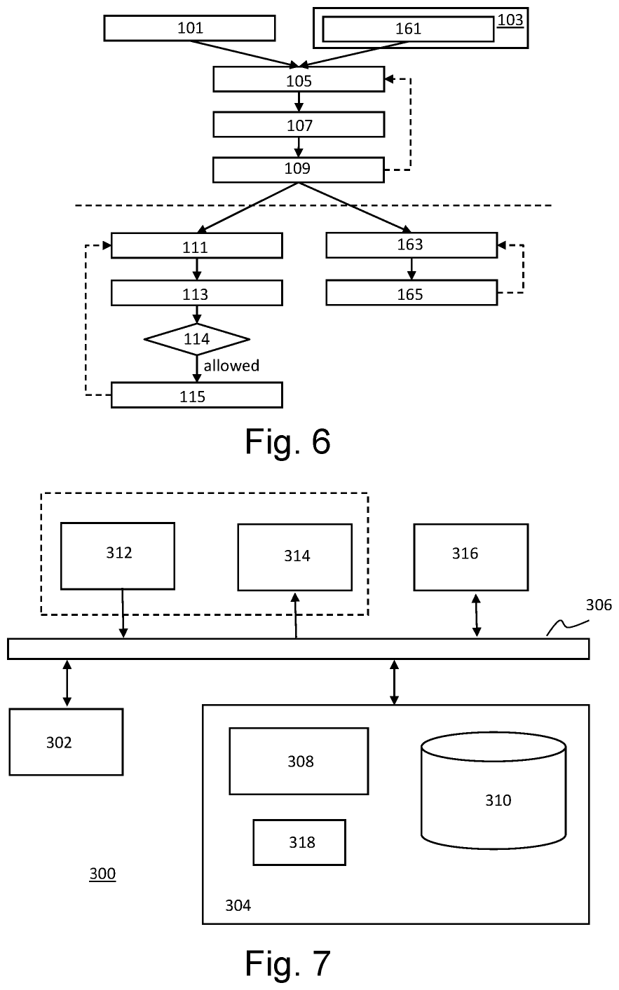

A third embodiment of the method of accessing a component of a lighting system is shown in FIG. 6. The third embodiment of FIG. 6 is an extension of the first embodiment of FIG. 4. In the embodiment of FIG. 6, step 103 of FIG. 4 is implemented by a step 161 and steps 163 and 165 are performed after step 109. The method may be performed by the bridge 1 of FIG. 1 or the computer 21 of FIG. 3, for example.

Step 161 comprises obtaining user information specifying user names in which at least part of the user information is obtained from at least one user device. This part of the user information specifies one or more user names associated with one or more accounts on the at least one user device. By gathering the names of the user from device names, e.g.

phone names, instead of, or in addition to, by user entry, the automatic setting of access rights becomes less work for the administrator. The at least one user device may, for example, comprise a user device which is capable of transmitting the request to access the component, e.g. a mobile phone with a lighting control app installed.

Steps 163 comprises obtaining an input signal indicative of a modification to the access rights stored in step 109 for the component requested by an authorized requestor. For example, the user or the device that installs/commissions the system may be designated as administrator and thereby become an authorized requestor and this user may be allowed to designate other users or devices as administrator.

Step 165 comprises making the modification of the access rights in the memory. Steps 163 and 165 make it possible for (authorized) users to finetune the access rights stored in step 109. Steps 163 and 165 may be repeated one or more times. Steps 163 and 165 may be performed before and/or after the first time steps 111 to 115 are performed. Thus, after the access rights have been prepopulated based on the user information, the user can tweak the access rights as necessary; the user does not have to start from scratch.

The embodiments of FIGS. 4 to 6 differ from each other in multiple aspects, i.e. multiple steps have been added or replaced. In variations on these embodiments, only a subset of these steps is added or replaced and/or one or more steps is omitted. As a first example, steps 163 and 165 may be omitted from the embodiment of FIG. 6 and/or added to the embodiments of FIGS. 4 and 5. As a second example, step 161 may be omitted from the embodiment of FIG. 6 and/or added to the embodiments of FIGS. 4 and 5. Multiple, e.g. all, of the embodiments of FIGS. 4 to 6 may be combined.

FIG. 7 depicts a block diagram illustrating an exemplary data processing system that may perform the method as described with reference to FIGS. 4 to 6.

As shown in FIG. 7, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 7, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 7) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

FIG. 7 shows the input device 312 and the output device 314 as being separate from the network adapter 316. However, additionally or alternatively, input may be received via the network adapter 316 and output be transmitted via the network adapter 316. For example, the data processing system 300 may be a cloud server. In this case, the input may be received from and the output may be transmitted to a user device that acts as a terminal.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for accessing a component of a lighting system, said system comprising:
at least one input interface;
at least one output interface; and
at least one processor configured to:
obtain component information specifying names of components of said lighting system,
obtain user information specifying user names,
look up a component name of a component of said lighting system in said component information,
determine access rights for said component by determining whether said component name comprises a user name of said user names,
store said access rights in a memory,
receive, via said at least one input interface, a request to access said component, said request identifying a requestor,
determine, based on said access rights for said component stored in said memory, whether said requestor, associated with a user name of said user names, is allowed to access said component, and
access said component via said at least one output interface upon determining that said requestor is allowed to access said component.

2. A system as claimed in claim 1, wherein said at least one processor is configured to determine said access rights for said component by enabling access to said component by a plurality of requestors if said component name does not include any of said user names.

3. A system as claimed in claim 2, wherein said at least one processor is configured to determine said access rights for said component by enabling access to said component by any requestor of said plurality of requestors if said component name does not include any of said user names.

4. A system as claimed in claim 1, wherein said component information further specifies names of component groups of said lighting system and said at least one processor is configured to:
look up a group name of a group of said component in said component information, and
determine said access rights for said component by determining whether said component name or said group name comprises a user name of said user names.

5. A system as claimed in claim 4, wherein said at least one processor is configured to determine said access rights for said component by enabling access to said component by said requestor if a user name associated with said requestor is included in said component name or in said group name, said user name being included in said user names.

6. A system as claimed in claim 1, wherein said components of said lighting system comprise at least one of: a lighting device, a sensor, a light scene, and an automation.

7. A system as claimed in claim 1, wherein accessing said component comprises controlling said component.

8. A system as claimed in claim 1, wherein accessing said component comprises configuring said component.

9. A system as claimed in claim 1 wherein said at least one processor is configured to:
obtain an input signal indicative of a modification to said access rights for said component requested by an authorized requestor, and
make said modification of said access rights in said memory.

10. A system as claimed in claim 1, wherein said at least one processor is configured to obtain at least part of said user information from at least one user device, said part of said user information specifying one or more user names associated with one or more accounts on said at least one user device.

11. A system as claimed in claim 9, wherein said at least one user device comprises a user device which is capable of transmitting said request to access said component.

12. A method of accessing a component of a lighting system, said method comprising:
obtaining component information specifying names of components of said lighting system;
obtaining user information specifying user names;
looking up a component name of a component of said lighting system in said component information;
determining access rights for said component by determining whether said component name comprises a user name of said user names;
storing said access rights in a memory;
receiving a request to access said component, said request identifying a requestor;
determining, based on said access rights for said component stored in said memory, whether said requestor, associated with a user name of said user names, is allowed to access said component; and
accessing said component upon determining that said requestor is allowed to access said component.

13. A computer program product for a computing device, the computer program product comprising computer program code to perform the method of claim 12 when the computer program product is run on a processing unit of the computing device.
